(19) United States
(12) Patent Application Publication
(10) Pub. No.: US 2025/0063317 A1
(43) Pub. Date: Feb. 20, 2025

(54) AN AUDIO APPARATUS AND METHOD OF OPERATION THEREFOR

(71) Applicant: KONINKLIJKE PHILIPS N.V., EINDHOVEN (NL)

(72) Inventors: Jeroen Gerardus Henricus Koppens, Nederweert (NL); Sam Martin Jelfs, Valkenswaard (NL)

(21) Appl. No.: 18/725,844

(22) PCT Filed: Jan. 9, 2023
(86) PCT No.: PCT/EP2023/050310

§ 371 Date: Jul. 1, 2024

(30) Foreign Application Priority Data
Jan. 11, 2022 (EP) 22150868.2

(51) Int. Cl. H04S 7/00

(52) U.S. Cl. CPC H04S 7/302; H04S 7/305; H04S 2400/11

(57) ABSTRACT

An audio apparatus comprises a first receiver (501) receiving audio data for audio sources of a scene comprising multiple rooms. A determiner (509) determines a room comprising a listening position and a neighbor room. A second receiver (503) receives spatial acoustic transmission data describing a number of transmission boundary regions for the listening room having an acoustic transmission level of sound from the neighbor room to the listening room exceeding a threshold. A first reverberator (511) determines a reverberation audio signal for the neighbor room. A sound source circuit (513) determines a sound source position in the neighbor room for a transmission boundary region. A renderer (507) renders an audio signal for the listening position which includes an audio component generated by rendering the second room reverberation audio signal from the sound source position. An improved rendering of multi-room scenes can be achieved.

### FIELD OF THE INVENTION

The invention relates to an apparatus and method for generating an audio signal, and in particular, but not exclusively, for rendering audio for a multi-room scene as part of e.g. an eXtended Reality experience.

### BACKGROUND OF THE INVENTION

The variety and range of experiences based on audiovisual content have increased substantially in recent years with new services and ways of utilizing and consuming such content continuously being developed and introduced. In particular, many spatial and interactive services, applications and experiences are being developed to give users a more involved and immersive experience.

Examples of such applications are eXtended Reality (XR) which is a common term referring to Virtual Reality (VR), Augmented Reality (AR), and Mixed Reality (MR) applications, which are rapidly becoming mainstream, with a number of solutions being aimed at the consumer market. A number of standards are also under development by a number of standardization bodies. Such standardization activities are actively developing standards for the various aspects of VR/AR/MR systems including e.g. streaming, broadcasting, rendering, etc.

VR applications tend to provide user experiences corresponding to the user being in a different world/environment/scene whereas AR (including Mixed Reality MR) applications tend to provide user experiences corresponding to the user being in the current environment but with additional information or virtual objects or information being added. Thus, VR applications tend to provide a fully immersive synthetically generated world/scene whereas AR applications tend to provide a partially synthetic world/scene which is overlaid the real scene in which the user is physically present. However, the terms are often used interchangeably and have a high degree of overlap. In the following, the term eXtended Reality/XR will be used to denote both Virtual Reality and Augmented/Mixed Reality.

As an example, a service being increasingly popular is the provision of images and audio in such a way that a user is able to actively and dynamically interact with the system to change parameters of the rendering such that this will adapt to movement and changes in the user's position and orientation. A very appealing feature in many applications is the ability to change the effective viewing position and viewing direction of the viewer, such as for example allowing the viewer to move and “look around” in the scene being presented.

Such a feature can specifically allow a virtual reality experience to be provided to a user. This may allow the user to (relatively) freely move about in a virtual scene and dynamically change his position and where he is looking. Typically, such virtual reality applications are based on a three-dimensional model of the scene with the model being dynamically evaluated to provide the specific requested view. This approach is well known from e.g. game applications, such as in the category of first person shooters, for computers and consoles.

It is also desirable, in particular for virtual reality applications, that the image being presented is a three-dimensional image, typically presented using a stereoscopic display. Indeed, in order to optimize immersion of the viewer, it is typically preferred for the user to experience the presented scene as a three-dimensional scene. Indeed, a virtual reality experience should preferably allow a user to select his/her own position, viewpoint, and moment in time relative to a virtual world.

In addition to the visual rendering, most XR applications further provide a corresponding audio experience. In many applications, the audio preferably provides a spatial audio experience where audio sources are perceived to arrive from positions that correspond to the positions of the corresponding objects in the visual scene. Thus, the audio and video scenes are preferably perceived to be consistent and with both providing a full spatial experience.

For example, many immersive experiences are provided by a virtual audio scene being generated by headphone reproduction using binaural audio rendering technology. In many scenarios, such headphone reproduction may be based on headtracking such that the rendering can be made responsive to the user's head movements. This highly increases the sense of immersion.

An important feature for many applications is that of how to generate and/or distribute audio that can provide a natural and realistic perception of the audio scene. For example, when generating audio for a virtual reality application, it is important that not only are the desired audio sources generated but also that these are generated to provide a realistic perception of the audio environment including damping, reflection, coloration etc.

For room/environment acoustics, reflections of sound waves off walls, floor, ceiling, objects etc. cause delayed and attenuated (typically frequency dependent) versions of the sound source signal to reach the listener (i.e. the user for a XR system) via different paths. The combined effect can be modelled by an impulse response which may be referred to as a Room Impulse Response (RIR).

As illustrated in FIG. 1, a RIR typically consists of a direct sound that depends on distance of the sound source to the listener, followed by a reflection portion that characterizes the acoustic properties of the room. The size and shape of the room, the position of the sound source and listener in the room and the reflective properties of the room's surfaces all play a role in the characteristics of this reverberant portion.

The reflective portion can be broken down into two temporal regions, usually overlapping. The first region contains so-called early reflections, which represent isolated reflections of the sound source on walls or obstacles inside the room prior to reaching the listener. As the time lag/(propagation) delay increases, the number of reflections present in a fixed time interval increases and the paths may include secondary or higher order reflections (e.g. reflections may be off several walls or both walls and ceiling etc).

The second region referred to as the reverberant portion is the part where the density of these reflections increases to a point where they cannot anymore be isolated by the human brain. This region is typically called the diffuse reverberation, late reverberation, or reverberation tail, or simply reverberation.

The RIR contains cues that give the auditory system information about the distance of the source, and of the size and acoustical properties of the room. The energy of the reverberant portion in relation to that of the anechoic portion largely determines the perceived distance of the sound source. The level and delay of the earliest reflections may provide cues about how close the sound source is to a wall, and the filtering by anthropometrics may strengthen the assessment of the specific wall, floor or ceiling.

The density of the (early-) reflections contributes to the perceived size of the room. The time that it takes for the reflections to drop 60 dB in energy level, indicated by the reverberation time T₆₀, is a frequently used measure for how fast reflections dissipate in the room. The reverberation time provides information on the acoustical properties of the room, such as specifically whether the walls are very reflective (e.g. bathroom) or there is much absorption of sound (e.g. bedroom with furniture, carpet and curtains).

Furthermore, RIRs may be dependent on a user's anthropometric properties when it is a part of a binaural room impulse response (BRIR), due to the RIR being filtered by the head, ears and shoulders; i.e. the head related impulse responses (HRIRs).

As the reflections in the late reverberation cannot be differentiated and isolated by a listener, they are often simulated and represented parametrically with, e.g., a parametric reverberator using a feedback delay network, as in the well-known Jot reverberator.

For early reflections, the direction of incidence and distance dependent delays are important cues to humans to extract information about the room and the relative position of the sound source. Therefore, the simulation of early reflections must be more explicit than the late reverberation. In efficient acoustic rendering algorithms, the early reflections are therefore simulated differently and separately from the later reverberation. A well-known method for early reflections is to mirror the sound sources in each of the room's boundaries to generate a virtual sound source that represents the reflection.

For early reflections, the position of the user and/or sound source with respect to the boundaries (walls, ceiling, floor) of a room is relevant, while for the late reverberation, the acoustic response of the room is diffuse and therefore tends to be homogeneous throughout the room. This allows simulation of late reverberation to often be more computationally efficient than early reflections.

Two main properties of the late reverberation are the slope and amplitude of the impulse response for times above a given threshold. These properties tend to be strongly frequency dependent in natural rooms. Often the reverberation is described using parameters that characterize these properties.

An example of parameters characterizing a reverberation is illustrated in FIG. 2. Examples of parameters that are traditionally used to indicate the slope and amplitude of the impulse response corresponding to diffuse reverberation include the known T₆₀ value and the reverb level/energy. More recently other indications of the amplitude level have been suggested, such as specifically parameters indicating the ratio between diffuse reverberation energy and the total emitted source energy.

Specifically, a Diffuse to Source Ratio, DSR, may be used to express the amount of diffuse reverberation energy or level of a source received by a user as a ratio of total emitted energy of that source. The DSR may represent the ratio between emitted source energy and a diffuse reverberation property, such as specifically the energy or the (initial) level of the diffuse reverberation signal:

$$D S R = \frac{diffuse reverb energy}{total emitted energy}$$

Henceforth this will be referred to as DSR (Diffuse-to-Source Ratio).

Such known approaches tend to provide efficient descriptions of audio propagation in a room and tend to lead to rendering of audio that is perceived as natural for the room in which the listener is (virtually) present.

However, whereas conventional approaches for representing and rendering sound in a room may provide a suitable perception in many embodiments, it tends to not be suitable for all possible scenarios. In particular, for audio scenes that may include different acoustic regions/rooms, the generated audio signal using the described reverberation approach may not lead to an optimal experience or perception. It may typically lead to situations where the audio from other rooms is not sufficiently or accurately represented by the rendered audio resulting in a perception that may not fully reflect the acoustic scenario and scene.

Indeed, typically, the reverberation is modelled for a listener inside the room taking into account the properties of the room. When the listener is outside the room, or in a different room, the reverberator may be turned off or reconfigured for the other room's properties. Even when multiple reverberators can be run in parallel, the output of the reverberators typically is a diffuse binaural (or multi-loudspeaker) signal intended to be presented to the listener as being inside the room. However, such approaches tend to result in audio being generated which is often not perceived to be an accurate representation of the actual environment. This may for example lead to a perceived disconnect or even conflict between the visual perception of a scene and the associated audio being rendered.

Thus, whereas typical approaches for rendering audio may in many embodiments be suitable for rendering the audio of an environment, they tend to be suboptimal in some scenarios, including in particular when rendering audio for scenes that include different acoustic rooms.

Hence, an improved approach for rendering audio for a scene would be advantageous. In particular, an approach that allows improved operation, increased flexibility, reduced complexity, facilitated implementation, an improved audio experience, improved audio quality, reduced computational burden, improved suitability for varying positions, improved performance for virtual/mixed/augmented reality applications, increased processing flexibility, improved representation and rendering of audio and audio properties of multiple rooms, improved audio rendering for multi-room scenes, and/or improved performance and/or operation would be advantageous.

### SUMMARY OF THE INVENTION

Accordingly, the Invention seeks to preferably mitigate, alleviate or eliminate one or more of the above-mentioned disadvantages singly or in any combination.

According to an aspect of the invention there is provided an audio apparatus comprising: a first receiver arranged to receive audio data for audio sources of a scene comprising multiple rooms; a position circuit arranged to determine a listening position in the scene; a determiner arranged to determine a first room comprising the listening position and a second room being a neighbor room of the first room; a second receiver arranged to receive spatial acoustic transmission data for the first room and the second room, the spatial acoustic transmission data describing a number of transmission boundary regions for the first room, each transmission boundary region having an acoustic transmission level for sound from the second room to the first room exceeding a threshold; a first reverberator arranged to determine a second room reverberation audio signal for the second room from at least one audio source in the second room and at least one of a geometric property of the second room and an acoustic property of the second room; a sound source circuit arranged to, for at least a first transmission boundary region of the number of transmission boundary regions, determine a sound source position in the second room for an audio source; a renderer arranged to render an audio signal for the listening position to include a first audio component generated by rendering the second room reverberation audio signal from the sound source position.

The approach may allow an improved user experience and may in many scenarios provide an improved rendering of audio of a scene. The approach may allow an improved audio rendering for multi-room scenes. A more natural and/or accurate audio perception of a scene may be achieved in many scenarios.

The invention may provide improved and/or facilitated rendering of audio including reverberation components. The rendering of the audio signal may often be achieved with reduced complexity and reduced computational resource requirements.

The approach may provide improved, increased, and/or facilitated flexibility and/or adaptation of the processing and/or the rendered audio.

In many embodiments, the renderer may be arranged to render the first audio component as a localized audio source. The localized audio source may be a (spatial) extent localized audio source, or may e.g. be a point source.

The first reverberator may be a diffuse reverberator. The first reverberator may comprise (or be) a parametric reverberator, such as a Feedback Delay Network (FDN) reverberator, and specifically a Jot Reverberator.

The audio source may be an audio source of the second room reverberation signal for the listening position being in the first room.

The acoustic transmission level may be an acoustic gain and/or transparency.

In accordance with an optional feature of the invention, the rendering is dependent on at least one of a geometric property of the first transmission boundary region and an acoustic property of the first transmission boundary region.

This may provide improved performance and/or facilitated implementation in many scenarios. It may assist in providing an improved user experience when perceiving audio of a multi-room scene. A geometric property may be a spatial property and may also be referred to as such.

In accordance with an optional feature of the invention, the sound source circuit is arranged to determine the sound source position subject to a requirement that a distance from the sound source position to the first transmission boundary region is no less than a tenth of a maximum distance within the first transmission boundary region.

This may provide improved performance and/or facilitated implementation in many scenarios. It may assist in providing an improved user experience when perceiving audio of a multi-room scene.

In accordance with an optional feature of the invention, the sound source circuit is arranged to determine the sound source position subject to a requirement that a distance from the sound source position to the first transmission boundary region is no less than a tenth of a maximum distance within the second room.

This may provide improved performance and/or facilitated implementation in many scenarios. It may assist in providing an improved user experience when perceiving audio of a multi-room scene.

In accordance with an optional feature of the invention, the sound source circuit is arranged to determine the sound source position subject to a requirement that a distance from the sound source position to the first transmission boundary region is no less than 20 cm.

This may provide improved performance and/or facilitated implementation in many scenarios. It may assist in providing an improved user experience when perceiving audio of a multi-room scene.

In accordance with an optional feature of the invention, the renderer is arranged to generate the first audio component by rendering the second room reverberation audio signal from the sound source position to the listening position along an acoustic path passing through the first transmission boundary region.

This may allow improved performance in many embodiments and may allow an improved audio rendering and/or user experience. It may typically allow a rendering that provides a perception of the second room reverberation signal as being from a localized sound source. The acoustic path may be a direct acoustic path.

In accordance with an optional feature of the invention, the rendering includes generating a second audio component by rendering the second room reverberation signal as a reverberation audio component.

This may allow improved performance in many embodiments and may allow an improved audio rendering and/or user experience. It may allow a more flexible adaptation that provides a more naturally sounding audio scene. The reverberation audio component may be a diffuse audio component. The reverberation audio component may be a component not having spatial cues. The reverberation audio component may be without spatial cues indicative of a spatial source position for the reverberation audio component.

In accordance with an optional feature of the invention, the rendering includes adapting a level of the first audio component relative to a level of the second audio component in response to the listening position relative to a position of the first transmission boundary region.

This may allow improved performance in many embodiments and may allow an improved audio rendering and/or user experience. It may for example allow a more naturally sounding flexible transition between audio experiences of the first and second room. For example, a gradual transition when the listening position changes from being in the first room to being in the second room may be provided.

In accordance with an optional feature of the invention, the rendering includes increasing the level of the first audio component relative to the level of the second audio component for an increasing distance from the listening position to the second room.

This may allow improved performance in many embodiments and may allow an improved audio rendering and/or user experience.

In accordance with an optional feature of the invention, the rendering includes adapting a level of the first audio component relative to a level of the second audio component in response to a size of the first transmission boundary region.

This may allow improved performance in many embodiments and may allow an improved audio rendering and/or user experience. It may for example allow a more naturally sounding flexible transition between audio experiences of the first and second room. For example, a gradual transition when the listening position changes from being in the first room to being in the second room may be provided.

In some embodiments, the rendering includes adapting a level of the first audio component relative to a level of the second audio component in response to a geometric/spatial property of the first transmission boundary region.

In accordance with an optional feature of the invention, the renderer is arranged to render the second room reverberation audio signal from the sound source position as a spatially extended sound source.

This may allow an improved audio scene to be rendered in many scenarios.

In accordance with an optional feature of the invention, the renderer comprises: a path renderer for rendering audio for acoustic paths; a plurality of reverberators arranged to generate reverberation signals for rooms, the plurality of reverberators including the first reverberator arranged to generate the second room reverberation audio signal; a coupling circuit for coupling reverberation signals from the plurality of reverberators to the path renderer; a combination circuit for combining reverberation signals from the plurality of reverberators including the second room reverberation audio signal and an output signal from the path renderer to generate a combined audio signal; and an adapter for adapting levels of the reverberation signals for the coupling by the coupling circuit and for the combination by the combination circuit.

This may provide improved performance and/or facilitated implementation in many scenarios. It may assist in providing an improved user experience when perceiving audio of a multi-room scene. The approach may further allow a very efficient and low complexity implementation in many embodiments.

In accordance with an optional feature of the invention, the adapter is arranged to adapt the levels of the reverberation signals in response to at least one of: metadata received with the audio data for the audio sources; an acoustic property of the first transmission boundary region; a geometric property of the first transmission boundary region; the listening position; an acoustic distance from the listening position to the sound source position; and a size of the first transmission boundary region.

This may provide improved performance and in particular may in many embodiments provide an improved and/or more flexible and/or adaptable rendering of a multi-room audio scene.

In accordance with an optional feature of the invention, the first reverberator is further arranged to generate the second room reverberation signal in response to a first room reverberation signal.

This may allow an improved audio scene to be rendered in many scenarios.

In accordance with an optional feature of the invention, the audio apparatus of any previous claim wherein the sound source circuit is arranged to generate the sound source position based on a position of the first transmission boundary region

This may allow an improved audio scene to be rendered in many scenarios. The position of the first transmission boundary region may be a nearest position, a center position, and edge position, a predetermined position, etc.

In some embodiments, the rendering includes adapting a level of the first audio component relative to a level of the second audio component in response to a distance between the listening position and a position of the first transmission boundary region.

In some embodiments, the sound source circuit may be arranged to generate the sound source position as a function of a position of the first transmission boundary region. This may allow an improved audio scene to be rendered in many scenarios. The position of the first transmission boundary region may be a nearest position, a center position, and edge position, a predetermined position, etc.

According to an aspect of the invention there is provided a method of operation for an audio apparatus, the method comprising: receiving audio data for audio sources of a scene comprising multiple rooms; determining a listening position in the scene; determining a first room comprising the listening position and a second room being a neighbor room of the first room; receiving spatial acoustic transmission data for the first room and the second room, the spatial acoustic transmission data describing a number of transmission boundary regions for the first room, each transmission boundary region having an acoustic transmission level of sound from the second room to the first room exceeding a threshold; determining a second room reverberation audio signal for the second room from at least one audio source in the second room and at least one of a geometric property of the second room and an acoustic property of the second room; for at least a first transmission boundary region of the number of transmission boundary regions, determining a sound source position in the second room for an audio source; rendering an audio signal for the listening position to include a first audio component generated by rendering the second room reverberation audio signal from the sound source position.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a room impulse response;

FIG. 2 illustrates an example of a room impulse response;

FIG. 3 illustrates an example of elements of virtual reality system;

FIG. 4 illustrates an example of a scene with three rooms;

FIG. 5 illustrates an example of an audio apparatus for generating an audio output in accordance with some embodiments of the invention;

FIG. 6 illustrates an example of a renderer;

FIG. 7 illustrates an example of a transition region between two rooms in accordance with an embodiment of the invention;

FIG. 8 illustrates an example of a transition region between two rooms in accordance with an embodiment of the invention;

FIG. 9 illustrates an example of a transition region between two rooms in accordance with an embodiment of the invention; and

FIG. 10 illustrates an example of an audio apparatus for generating an audio output in accordance with some embodiments of the invention.

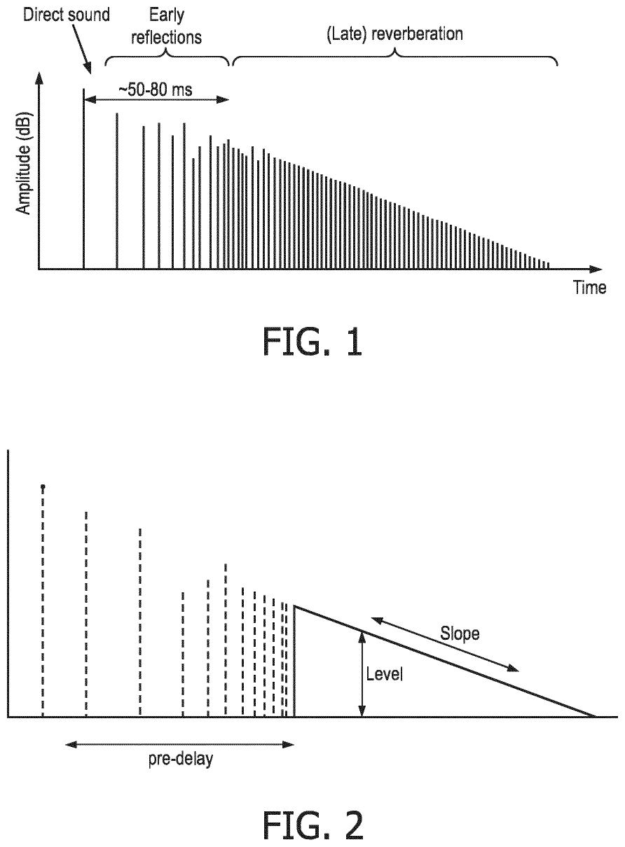

### DETAILED DESCRIPTION OF SOME EMBODIMENTS OF THE INVENTION

The following description will focus on audio processing and rendering for an eXtended Reality application, but it will be appreciated that the described principles and concepts may be used in many other applications and embodiments.

Virtual experiences allowing a user to move around in a virtual world are becoming increasingly popular and services are being developed to satisfy such a demand.

In some systems, the VR application may be provided locally to a viewer by e.g. a stand-alone device that does not use, or even have any access to, any remote VR data or processing. For example, a device such as a games console may comprise a store for storing the scene data, input for receiving/generating the viewer pose, and a processor for generating the corresponding images from the scene data.

In other systems, the VR application may be implemented and performed remote from the viewer. For example, a device local to the user may detect/receive movement/pose data which is transmitted to a remote device that processes the data to generate the viewer pose. The remote device may then generate suitable view images and corresponding audio signals for the user pose based on scene data describing the scene. The view images and corresponding audio signals are then transmitted to the device local to the viewer where they are presented. For example, the remote device may directly generate a video stream (typically a stereoscopic/3D video stream) and corresponding audio stream which is directly presented by the local device. Thus, in such an example, the local device may not perform any VR processing except for transmitting movement data and presenting received video data.

In many systems, the functionality may be distributed across a local device and remote device. For example, the local device may process received input and sensor data to generate user poses that are continuously transmitted to the remote VR device. The remote VR device may then generate the corresponding view images and corresponding audio signals and transmit these to the local device for presentation. In other systems, the remote VR device may not directly generate the view images and corresponding audio signals but may select relevant scene data and transmit this to the local device, which may then generate the view images and corresponding audio signals that are presented. For example, the remote VR device may identify the closest capture point and extract the corresponding scene data (e.g. a set of object sources and their position metadata) and transmit this to the local device. The local device may then process the received scene data to generate the images and audio signals for the specific, current user pose. The user pose will typically correspond to the head pose, and references to the user pose may typically equivalently be considered to correspond to the references to the head pose.

In many applications, especially for broadcast services, a source may transmit or stream scene data in the form of an image (including video) and audio representation of the scene which is independent of the user pose. For example, signals and metadata corresponding to audio sources within the confines of a certain virtual room may be transmitted or streamed to a plurality of clients. The individual clients may then locally synthesize audio signals corresponding to the current user pose. Similarly, the source may transmit a general description of the audio environment including describing audio sources in the environment and acoustic characteristics of the environment. An audio representation may then be generated locally and presented to the user, for example using binaural rendering and processing.

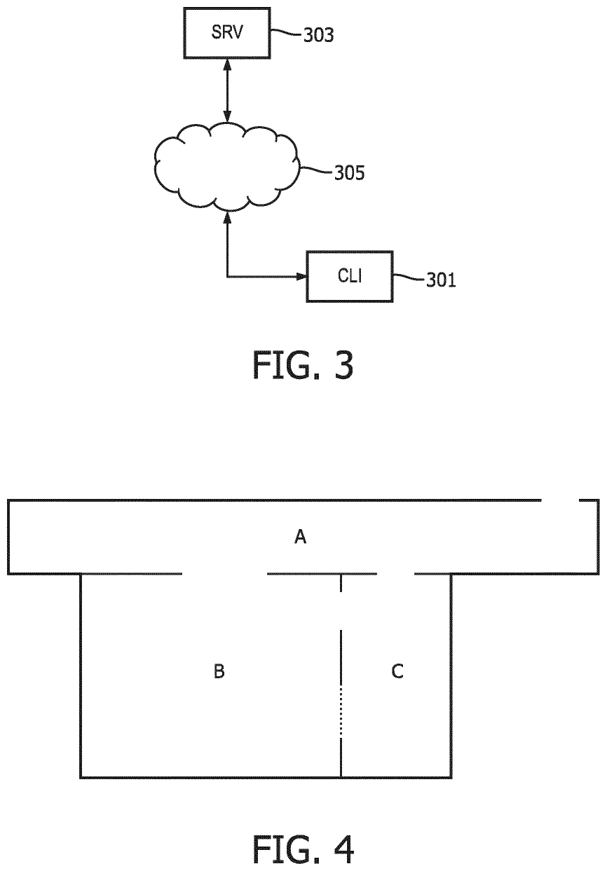

FIG. 3 illustrates such an example of a VR system in which a remote VR client device 301 liaises with a VR server 303 e.g. via a network 305, such as the Internet. The server 303 may be arranged to simultaneously support a potentially large number of client devices 301.

The VR server 303 may for example support a broadcast experience by transmitting an image signal comprising an image representation in the form of image data that can be used by the client devices to locally synthesize view images corresponding to the appropriate user poses (a pose refers to a position and/or orientation). Similarly, the VR server 303 may transmit an audio representation of the scene allowing the audio to be locally synthesized for the user poses. Specifically, as the user moves around in the virtual environment, the image and audio synthesized and presented to the user is updated to reflect the current (virtual) position and orientation of the user in the (virtual) environment.

In many applications, such as that of FIG. 3, it may thus be desirable to model a scene and generate an efficient image and audio representation that can be efficiently included in a data signal that can then be transmitted or streamed to various devices which can locally synthesize views and audio for different poses than the capture poses.

In some embodiments, a model representing a scene may for example be stored locally and may be used locally to synthesize appropriate images and audio. For example, an audio model of a room may include an indication of properties of audio sources that can be heard in the room as well as acoustic properties of the room. The model data may then be used to synthesize the appropriate audio for a specific position.

In many scenarios, the scene may include a number of different acoustic environments or regions that have different acoustic properties and specifically have different reverberation properties. Specifically, the scene may include or be divided into different acoustic environments/regions that each have homogenous reverberation but between which the reverberation is different. For all positions within an acoustic environment/region, a reverberation component of audio received at the positions may be homogeneous, and specifically may be substantially the same (except potentially for a gain difference). An acoustic environment/region may be a set of positions for which a reverberation component of audio is homogeneous. An acoustic environment/region may be a set of positions for which a reverberation component of the audio propagation impulse response for audio sources in the acoustic environment is homogeneous. Specifically, an acoustic environment/region may be a set of positions for which a reverberation component of the audio propagation impulse response for audio sources in the acoustic environment has the same frequency dependent slope- and/or amplitude properties except for possibly a gain difference. Specifically, an acoustic environment/region may be a set of positions for which a reverberation component of the audio propagation impulse response for audio sources in the acoustic environment is the same except for possibly a gain difference.

An acoustic environment/region may typically be a set of positions (typically a 2D or 3D region) having the same rendering reverberation parameters. The reverberation parameters used for rendering a reverberation component may be the same for all positions in an acoustic environment/region. In particular, the same reverberation decay parameter (e.g. T₆₀) or Diffuse-to-Source Ratio, DSR, may apply to all positions within an acoustic environment/region.

Impulse responses may be different between different positions in a room/acoustic environment/region due to the ‘noisy’ characteristic resulting from many various reflections of different orders causing the reverberation. However, even in such a case, the frequency dependent slope- and/or amplitude properties may be the same (except for possibly a gain difference), especially when represented by e.g. the reverberation time (T60) or a reverberation coloration.

Acoustic environments/regions may also be referred to as acoustic rooms or simply as rooms. A room may be considered an environment/region as described above.

In many embodiments, a scene may be provided where acoustic rooms correspond to different virtual or real rooms between which a user may (e.g. virtually) move. An example of a scene with three rooms A, B, C is illustrated in FIG. 4. In the example, a user may move between the three rooms, or outside any room, through doorways and openings.

For a room to have substantial reverberation properties, it tends to represent a spatial region which is sufficiently bounded by geometric surfaces with wholly or partially reflecting properties such that a substantial part of the reflection in this room keep reflecting back into the region to generate a diffuse field of reflections in the region, having no significant directional properties. The geometric surfaces need not be aligned to any visual elements.

Audio rendering aimed at providing natural and realistic effects to a listener typically includes rendering of an acoustic scene. For many environments, this includes the representation and rendering of diffuse reverberation present in the environment, such as in a room where the listener is. The rendering and representation of such diffuse reverberation has been found to have a significant effect on the perception of the environment, such as on whether the audio is perceived to represent a natural and realistic environment.

In situations where the scene includes multiple rooms, the approach is typically to render the audio and reverberation only for the room in which the listener is present and to ignore any audio from other rooms. However, this tends to lead to audio experiences that are not perceived to be optimal and tends to not provide an optimal natural experience, particularly when the user transitions between rooms. Although some applications have been implemented to include rendering of audio from adjacent rooms, they have been found to be suboptimal.

In the following, advantageous approaches will be described for rendering an audio scene that includes multiple rooms. For clarity and brevity, the approach will be described mainly with reference to the exemplary scenario/scene of FIG. 4 in which three adjacent rooms A, B, C are included in the scene.

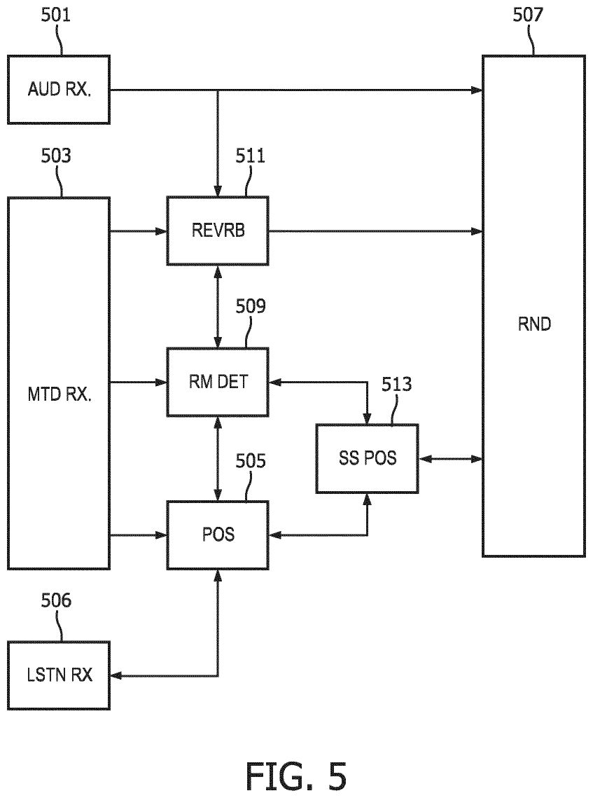

FIG. 5 illustrates an example of an audio apparatus that is arranged to render an audio scene. The audio apparatus may receive audio data describing audio and audio sources in a scene. In the particular example, the audio apparatus may receive audio data for the scene of FIG. 4. Based on the received audio data, the audio apparatus may render audio signals representing the scene for a given listening position. The rendered audio may include contributions both from audio generated in the room in which the listener is present as well as contributions from other neighbor, and typically adjacent, rooms.

The audio apparatus is arranged to generate an audio output signal that represents audio in the scene. Specifically, the audio apparatus may generate audio representing the audio perceived by a user moving around in the scene with a number of audio sources and with given acoustic properties. Each audio source is represented by an audio signal representing the sound from the audio source as well as metadata that may describe characteristics of the audio source (such as providing a level indication for the audio signal). In addition, metadata is provided to characterize the scene.

The renderer is in the example part of an audio apparatus which is arranged to receive audio data and metadata for a scene and to render audio representing at least part of the environment based on the received data.

The audio apparatus of FIG. 5 comprises a first receiver 501 which is arranged to receive audio data for audio sources in the scene. Typically, a number of e.g. point sources may be provided with audio data that reflects the sound to be rendered from those audio point sources. In some embodiments, audio data may also be provided for more diffuse audio sources, such as e.g. a background or ambient sound source, or sound sources with a spatial extent.

The audio apparatus comprises a second receiver 503 which is arranged to receive metadata characterizing the scene. The metadata may for example describe room dimensions, acoustic properties of the rooms (e.g. T60, DSR, material properties), the relationships between rooms etc. The metadata may further describe positions and orientations of some or all of the audio sources.

The metadata includes spatial acoustic transmission data for the different rooms. In particular, it includes data describing one or more transmission boundary regions for at least one, and typically for all, rooms of the scene. A transmission boundary region may specifically be a region for which an acoustic transmission level of sound from another room into the room for which the transmission boundary region is provided exceeds a threshold. Specifically, a transmission boundary region may define a region (typically an area) of a boundary between two rooms for which the attenuation by/across the boundary is less than a given threshold whereas it may be higher outside the region.

Thus, the transmission boundary regions may define regions of the boundary between two rooms for which an acoustic propagation/transmission/transparency/coupling exceeds a threshold. Parts of the boundary that are not included in a transmission boundary region may have an acoustic propagation/transmission/transparency/coupling above the threshold. Correspondingly, the transmission boundary regions may define regions of the boundary between two rooms for which an acoustic attenuation is below a threshold. Parts of the boundary that are not included in a transmission boundary region may have an acoustic attenuation above the threshold.

The transmission boundary region may thus indicate regions of a boundary for which the acoustic transparency is relatively high whereas it may be low outside the regions. A transmission boundary region may for example correspond to an opening in the boundary. For example, for conventional rooms, a transmission boundary region may e.g. correspond to a doorway, an open window, or a hole etc. in a wall separating the two rooms.

A transmission boundary region may be a three-dimensional or two-dimensional region. In many embodiments, boundaries between rooms are represented as two dimensional objects (e.g. walls considered to have no thickness) and a transmission boundary region may in such a case be a two-dimensional shape or area of the boundary which has a low acoustic attenuation.

The acoustic transparency can be expressed on a scale. Full transparency means there is no acoustic suppression present (e.g. an open doorway). Partial transparency could introduce an attenuation to the energy what transitioning from one room to the other (e.g. a thick curtain in a doorway, or a single pane window). On the other end of the scale are room separating materials that do not allow any (significant) acoustic leakage between rooms (e.g. a thick concrete wall).

The approach may thus (in the form of transmission boundary regions) provide acoustic linking metadata that describes how two rooms are acoustically linked. This data may be derived locally, or may e.g. be obtained from a received bitstream. The data may be manually provided by a content author, or derived indirectly from a geometric description of the room (e.g. boxes, meshes, voxelized representation, etc.) including acoustic properties such as material properties indicating how much audio energy is transmitted through the material, or coupled into vibrations of the material causing an acoustic link from one room to another.

The transmission boundary region may in many cases be considered to indicate room leaks, where acoustic energy may be exchanged between two rooms. This may be a binary indication (opening in boundary between rooms) or may be a scalar indication (reflecting that a part of the energy is transmitted through).

It will be appreciated that in many cases the audio data and metadata may be received as part of the same bitstream and the first and second receivers 501, 503 may be implemented by the same functionality and effectively the same receiver functionality may implement both the first and second receiver. The audio apparatus of FIG. 5 may specifically correspond to, or be part of, the client device 301 of FIG. 3 and may receive the audio data and metadata in a single bitstream transmitted from the server 303.

The apparatus further comprises a position circuit 505 arranged to determine a listening position in the scene. The listening position typically reflects the (virtual) position of the user in the scene. For example, the third receiver 506 may be coupled to a user tracking device, such as a VR headset, an eye tracking device, a motion capture camera etc., and may from this receive user movement (including or possibly limited to head movement and/or eye movement) data. The position circuit 505 may from this data continuously determine a current listening position.

This listening position may alternatively be represented by or augmented with controller input with which a user can move or teleport the listening position in the scene.

It will be appreciated that many approaches and techniques are known and used for determining listening positions in a scene for various applications, and that any suitable approach may be used without detracting from the invention.

The audio apparatus comprises a renderer 507 which is arranged to generate an audio output signal representing the audio of the scene at the listening position. Typically, the audio signal may be generated to include audio components for a range of different audio sources in the scene. For example, point audio sources in the same room may be rendered as point audio sources having direct acoustic paths, reverberation components may be rendered, or generated etc.

In the following an approach will be described in which the rendered audio signal includes audio signals/components that represent audio from other rooms than the one comprising the listening position. The description will focus on the generation of this audio component but it will be appreciated that the rendered audio signal presented to the user may include many other components and audio sources. These may be generated and processed in accordance with any suitable algorithm or approach, and it will be appreciated that the skilled person will be aware of a large number of such approaches.

The following description will focus on the generation/rendering of an audio signal (component) reflecting audio in one or more other rooms than the one currently comprising the listening position.

The audio apparatus specifically comprises a room determiner 509 which is arranged to determine a first room comprising the listening position and a second room which is a neighbor room, and typically an adjacent room of the first room. The room determiner 509 may receive the listening position data from the position circuit 505 and determine the current room for that listening position. It may then proceed to select an adjacent room to the current room and the audio apparatus may proceed to generate an audio signal component for the listening position for this adjacent room. As a specific example, a scenario may be considered where the listening position is currently in room B of FIG. 4 and the position circuit 505 may identify room A as an adjacent room. The audio apparatus then proceeds to render an audio signal component audio/sound from room A as heard from the listening position in room B.

It will be appreciated that the same process may be followed for room C, which may also be identified as an adjacent room to room B.

The audio apparatus comprises reverberator 511 which is arranged to generate a reverberation audio signal for the determined neighbor room, i.e. for room A in the specific example.

The room determiner 509 provides information to the reverberator 511 of reverberation properties of the determined room, i.e. for room A. It may do so directly or indirectly. For example, the room determiner 509 may indicate the selected neighbor room to the reverberator 511 and this may then extract the reverberation parameters for the selected room (i.e. room A in the example) from the received metadata. The reverberator 511 may then proceed to generate a reverberation signal which corresponds to the reverberation that is present in the neighbor room.

The reverberator 511 thus proceeds to generate a reverberation audio signal for the neighbor room based on at least one audio source in the neighbor room and at least one property of the second room, such as a geometric property (size, distance between boundaries/reflective walls etc.) or an acoustic property (attenuation, frequency response etc.).

For example, the reverberator 511 may extract a T₆₀ or DSR parameter provided for the neighbor room in the metadata. It may then proceed to select all sound sources in the neighbor room and provide the audio data for these as an input to the reverberation process. The reverberation signal may then be generated in accordance with a suitable reverberation algorithm. It will be appreciated that many algorithms and approaches are known and that any suitable approach may be used. For example, the reverberator 511 may implement a parametric reverberator such as a Jot reverberator.

The neighbor room reverberation signal is fed to the renderer 507 together with the audio source data for audio sources of the listening room (i.e. the room which comprises the listening position, i.e. room B in the specific example). The renderer 507 proceeds to then render an audio signal for the listening position which in addition to components for the audio sources in the listening room also includes a component corresponding to the neighbor room reverberation sound.

The rendering of the neighbor room reverberation signal may specifically include a rendering of the neighbor room reverberation signal as a localized audio source rather than as a diffuse non-spatial background source. The neighbor room reverberator 511 is thus not (always) rendered merely as diffuse reverberation audio but is rendered as a localized, or even point, source. A localized source may be a point source or a may have an extent but be spatially constrained.

The audio apparatus comprises a sound source circuit 513 arranged to determine a sound source position for the neighbor room reverberation signal. The renderer 507 is then arranged to render the neighbor room reverberation signal as a localized sound source from this sound source position. The rendering of the neighbor room reverberation signal may be as a point source from the sound source position or may be rendered as a spatially extended audio source (i.e. an extent audio source) that is positioned in response to the sound source position and/or which includes the sound source position.

The sound source position is specifically arranged to determine the sound source position based on the transmission boundary regions. It may in particular generate one sound source position for each transmission boundary region and a rendering of the neighbor room reverberation signal may be performed for each sound source position/transmission boundary region.

The sound source position is determined based on the transmission boundary region but is located within the neighbor room. Thus, the reverberation audio from the neighbor room is also rendered to listening positions in the listening room but such that it may be perceived to originate from a position that is in the neighbor room. It may thus not be perceived merely as a diffuse non-spatial sound but rather it may provide a spatial component. This may provide a more realistic perception of the scene in many scenarios.

In many embodiments, the sound source circuit 513 may for a transmission boundary region be arranged to generate the sound source position based on a position of the transmission boundary region. In many embodiments, the sound source circuit 513 may for transmission boundary region be arranged to generate the sound source position as a function of a position of the transmission boundary region. The position of the transmission boundary region may be a nearest position, a center position, and edge position, a predetermined position, etc.

In a multi-room scenario, each room typically has its own reverberation characteristics. Sources inside each room will contribute much stronger to the room they reside in, while contributing much weaker to the reverberation in other rooms. Therefore, the balance between all the sources in all the rooms is also different between the rooms.

Furthermore, when simulating rooms, the configuration is typically given by T60 and DSR, but the room dimensions also affect how fast and with which pattern reflections occur.

When a listener is moving from one room to another the reverberation of the room in which the listener is present can be rendered as a diffuse reverberation as known in the art. The reverberation of other rooms can in accordance with the described approach however be rendered as localizable sources on positions close to the boundaries between the rooms where there is significant acoustic transparency between the rooms. This may result in the reverberation of those rooms still being perceived, but rather than being perceived as diffuse and non-spatial they are perceived as localizable in the direction of the transparent parts of the boundary between the rooms. The reverberation of the neighbor rooms may be perceived as being heard coming from and through openings in the walls between the rooms. Further, the level of the reverberation from the other room may be attenuated with increasing distance from the listener to the reverberation source, similarly to the experience in in a physical situation.

The sound source position is determined to be within the neighbor room, i.e. the neighbor room reverberation signal is not rendered from within the listening room or even at the border between the two rooms but rather is rendered from a position that is within the neighbor room.

Such an approach is counterintuitive as rendering of audio in a room is considered to be performed to reflect the geometric and acoustic properties of the room. However, the Inventors have realized that an improved spatial perception can be perceived by determining the sound source position to be within the neighbor room. In particular, it has been found that this results in a perception of a more natural sound in a multi-room scene, and especially in the transition between rooms where the listening position is on or close to the transmission boundary region.

The sound source position may in many embodiments be determined to be within the room by a given minimum distance. The minimum distance may be a distance to the nearest transmission boundary region and/or to the nearest boundary point (i.e. point on the boundary). The minimum distance may be at least 20 cm, or in some cases, 30 cm, 50 cm, or 1 meter. The minimum distance may be a scene distance. The scene may typically correspond to a real-life scene in the sense that it measures distances that correspond to real-life distances. The minimum distances may be determined with reference to these.

In many embodiments, the minimum distance may be a relative distance, and specifically the minimum distance may be dependent on a size of the transmission boundary region. In many embodiments, the minimum distance for the sound source position to the transmission boundary region is no less than a tenth of a maximum distance of the transmission boundary region. In some embodiments, it may be no less than a fifth, half, or the maximum distance of the transmission boundary region.

Such an approach may provide a particularly advantageous operation in many scenarios and may typically result in a rendering that is perceived to provide a natural impression of the scene.

In some embodiments, the minimum distance may be a relative distance with respect to the listening room and/or the neighbor room.

In many embodiments, the minimum distance for the sound source position to the transmission boundary region is no less than a tenth of a maximum distance of the listening room and/or the neighbor room. In some embodiments, it may be no less than a fifth, half, or the maximum distance of the listening room/neighbor room.

Such an approach may provide a particularly advantageous operation in many scenarios and may typically result in a rendering that is perceived to provide a natural impression of the scene.

The sound source position may in many embodiments be determined to be within the room by a given maximum distance. The maximum distance may be a distance to the nearest transmission boundary region and/or to the nearest boundary point. The maximum distance may be no more than 1 m, or in some cases, 3 m, 5 m, or 10 meters. The maximum distance may be a scene distance. The scene may typically correspond to a real-life scene in the sense that it measures distances that correspond to real-life distances. The maximum distances may be determined with reference to these.

In many embodiments, the maximum distance may be a relative distance, and specifically the maximum distance may be dependent on a size of the transmission boundary region. In many embodiments, the maximum distance for the sound source position to the transmission boundary region is no more than half a maximum distance of the transmission boundary region. In some embodiments, it may be no less than a one, two, three or five times the maximum distance of the transmission boundary region.

Such an approach may provide a particularly advantageous operation in many scenarios and may typically result in a rendering that is perceived to provide a natural impression of the scene.

In some embodiments, the maximum distance may be a relative distance with respect to the listening room and/or the neighbor room.

In many embodiments, the maximum distance for the sound source position to the transmission boundary region is no less than a half of a maximum distance of listening room and/or the neighbor room. In some embodiments, it may be no less than a fifth or one third of the maximum distance of the listening room/neighbor room.

Such an approach may provide a particularly advantageous operation in many scenarios and may typically result in a rendering that is perceived to provide a natural impression of the scene.

In many embodiments the distance may be selected based on a consideration of a combination of measures. E.g. the source may be positioned at a fifth of the largest transmission boundary region away from the transmission boundary region, but at least 20 cm and at most a third of the smallest room dimension of the neighbor room.

The positioning of the sound source representing the reverberation signal of the neighbor room within the neighbor room, and specifically with this being proximal but not too close to the boundary, may provide a highly advantageous experience.

The positioning of the sound source in the neighbor room and somewhat away from the boundary may result in a more realistic transition where the directionally received reverberation is originating from the room, rather than the boundary. Especially at the boundary it may be more realistic to not be overlapping with the directional source. Thus, an improved user experience is achieved, e.g., when a user moves from one room into the neighbor room.

In particular, the described approach may often allow for a user position-based transition from a non-directional, diffuse reverberation into a directional reverberation before reaching the transmission boundary between two rooms where, at the boundary, the reverberation is substantially directional, originating from the room. This is in line with physical rooms, where reverberation is much less diffuse at these boundaries where there are no reverberation contributions from the direction of the transmission region.

If the source position were exactly on the boundary and be contributing to the audio signal for the listening position, its localization would not be realistic as it overlaps with the listening position, and may even be perceived to originate from the wrong room. It could be very sensitive to the listener moving across the boundary and causing the localization to flip from one side of the listener to the other.

Moreover, localizable sources are often rendered using a non-zero reference distance for which there is no distance attenuation needed for the signal. With the source at some distance from the boundary makes its distance attenuation operate more realistically for listening positions around the boundary and into the listening room.

Additionally, with the source positioned inside the neighbor room, its rendering by a direct acoustic path renderer (as is described below) may conveniently model occlusion and/or diffraction of, e.g., a door is wholly or partially closed in the transmission boundary region. With the source on the boundary, there is a risk the source is not occluded by the door geometry.

When rendering the reverberation signal from the position within the neighbor room, the renderer 507 is arranged to render the reverberation signal such that it comprises some spatial cues for the sound source position. Specifically, the rendering includes rendering for an acoustic path from the sound source position to the listening position where the acoustic path goes through the first transmission boundary region. The acoustic path may be a direct acoustic path from the sound source position to the listening position or may be a reflected acoustic path. Such a reflected acoustic path may typically include no more than one, two, three or five reflections. The reflections may for example of be off walls or boundaries of the listening room.

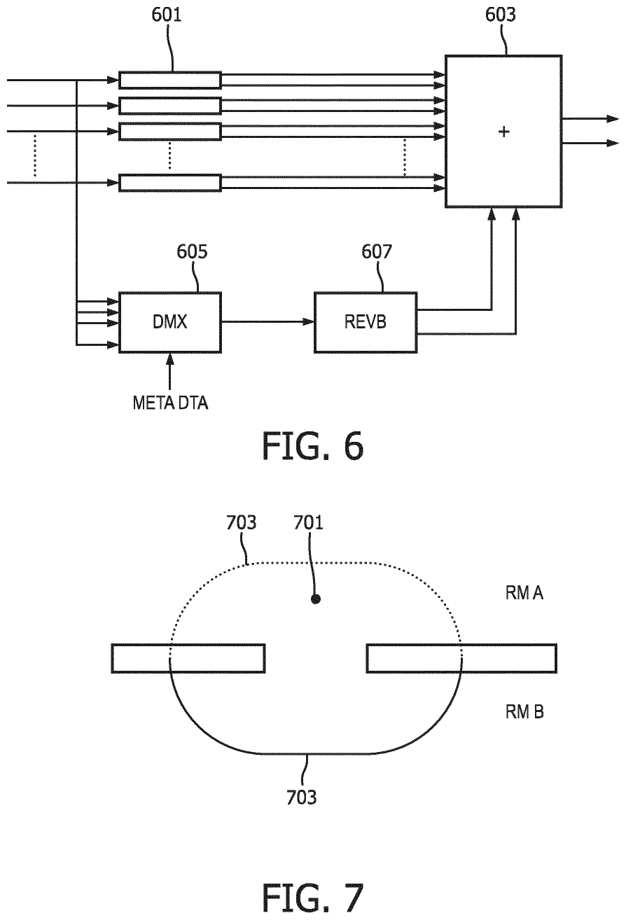

FIG. 6 illustrates an example of elements of the renderer 507. In the example, the renderer 600 comprises a path renderer 601 for each audio source. Each path renderer 601 is arranged to generate a direct path signal component representing the direct path from the audio source to the listener. The direct path signal component is generated based on the positions of the listener and the audio source and may specifically generate the direct signal component by scaling the audio signal, potentially frequency dependently, for the audio source depending on the distance and e.g. relative gain for the audio source in the specific direction to the user (e.g. for non-omnidirectional sources).

In many embodiments, the path renderer 601 may also generate the direct path signal based on occluding or diffracting (virtual) elements that are in between the source and user positions.

In many embodiments, the path renderer 601 may also generate further signal components for individual paths where these include one or more reflections. This may for example be done by evaluating reflections of walls, ceiling etc. as will be known to the skilled person. The direct path and reflected path components may be combined into a single output signal for each path renderer and thus a single signal representing the direct path and early/discrete reflections may be generated for each audio source.

In some embodiments, the output audio signal for each audio source may be a binaural signal and thus each output signal may include both a left ear and a right ear (sub)signal to include directional rendering for its direction with respect to the user's orientation (e.g. by applying Head Related Transfer Functions (HRTFs), Binaural Room Impulse Responses (BRIRs) or a loudspeaker panning algorithm).

The output signals from the path renderers 601 are provided to a combiner 603 which combines the signals from the different path renderers 601 to generate a single combined signal. In many embodiments, a binaural output signal may be generated and the combiner may perform a combination, such as a weighted combination, of the individual signals from the path renderers 601, i.e. all the right ear signals from the path renderers 601 may be added together to generate the combined right ear signals and all the left ear signals from the path renderers 601 may be added together to generate the combined left ear signals.

The path renderers 601 and combiner 603 may be implemented in any suitable way including typically as executable code for processing on a suitable computational resource, such as a microcontroller, microprocessor, digital signal processor, or central processing unit including supporting circuitry such as memory etc. It will be appreciated that the plurality of path renderers may be implemented as parallel functional units, such as e.g. a bank of dedicated processing units, or may be implemented as repeated operations for each audio source. Typically, the same algorithm/code is executed for each audio source/signal.

In addition to the individual path audio components, the renderer 507 is further arranged to generate a signal component representing the diffuse reverberation in the environment. The diffuse reverberation signal is in the specific example generated by combining the source signals into a downmix signal and then applying a reverberation algorithm to the downmix signal to generate the diffuse reverberation signal.

The audio apparatus of FIG. 6 comprises a downmixer 605 which receives the audio signals for a plurality of the sound sources (typically all sources inside the acoustic environment for which the reverberator is simulating the diffuse reverberation) and metadata for combining the audio signals into a downmix (the metadata may e.g. be provided by a content creator as part of the audiovisual data stream). The downmixer combines the audio signals into a downmix which accordingly reflects all the sound generated in the environment. The coefficients/weights for the individual audio signal may for example be set to reflect the (relative) level of the corresponding sound source, and optionally be combined with the DSR to control the level of the reverberation.

In many embodiments, sources positioned outside the room modelled by the reverberator may also contribute to the reverberation. However, these may typically contribute much less than sources inside the room, because only a portion of these outside sources reaches the room through any transmission boundary regions.

The downmix is fed to a reverberation renderer/reverberator 607 which is arranged to generate a diffuse reverberation signal based on the downmix. The reverberator 607 may specifically be a parametric reverberator such as a Jot reverberator. The reverberator 607 is coupled to the combiner 603 to which the diffuse reverberation signal is fed. The combiner 603 then proceeds to combine the diffuse reverberation signal with the path signals representing the individual paths to generate a combined audio signal that represents the combined sound in the environment as perceived by the listener.

In the example, all audio signals for audio sources in the listening room are fed to a path renderer and the renderer 507 proceeds to generate an output signal comprising contributions from all of these, including contributions corresponding to direct paths, reflected paths, and diffuse reverberation.

However, in addition, the output of the reverberator 511, i.e. the reverberation signal for the neighbor room, may also be fed to a path renderer 601. Thus, the same rendering that is used for rendering the audio sources within the listening room may also be used for the neighbor room reverberation signal positioned in the neighbor room.

In most cases, the reverberation signal is also fed to the reverberator 607 and thus a contribution to the diffuse sound in the listening room is also provided from the reverberation sound of the neighbor room.

Similarly, in some cases, the reverberation signal of the neighbor room may also be generated based on a reverberation signal of the listening room. For example, the reverberator 607 may be arranged to generate a reverberation signal which does not include any contribution from the neighbor room reverberation signal (but e.g. only from sound sources within the listening room itself). Instead, the generated reverberation signal for the listening room may be fed as an input to the reverberator 511 and may contribute to the generated neighbor room reverberation signal. Such an approach may in many scenarios provide improved and more accurate rendering of natural audio for the scene.

In many embodiments, the renderer 507 is arranged to render the neighbor room reverberation signal as a point source signal from the sound source position. However, in other embodiments, the renderer 507 may be arranged to render the neighbor room reverberation signal as a spatially extended audio source. Thus, in some embodiments, the neighbor room reverberation signal may be rendered as an audio source with an extent.

For example, a spatial extension of the sound source may be determined by the sound source circuit 513. As an example, the extent of the sound source may be determined dependent on the size of the transmission boundary region. As a specific example, the sound source may be determined to have a spatial extent that matches the size of the transmission boundary region.

The renderer 507 may then proceed to render the neighbor room reverberation signal such that it is perceived to have a spatial extent that matches the determined extension.

It will be appreciated that various approaches for rendering an audio source with a spatial extent are known and that any suitable approach may be used.

In some specific embodiments, the renderer 507 may be arranged to render an extent audio source by rendering it as a plurality of point sources that are distributed within the extent of the audio source. For example, an extent may be determined for the rendering of the neighbor room reverberation signal and a relatively large number, say 10-50, point sources that are distributed within the extent. The neighbor room reverberation signal may then be rendered from each point source resulting in an overall perception of a single audio source having a spatial extent.

Rendering each point source of the extent with a signal that is decorrelated to the other signals is typically advantageous in generating the perceived extent realistically. For this, decorrelators can be used. Alternatively, when using a Feedback Delay Network (FDN) reverberator, the extraction of signals from the feedback loops can be done with a set of mutually orthogonal extraction vectors to obtain a decorrelated reverberation signal with each extraction vector. A set of orthogonal vectors can, for example, be derived using the Gram-Schmidt process.

Rendering an audio source with an extent may in many embodiments, and in particular for large transmission boundary regions, provide an improved user experience and in particular a more realistic and naturally sounding contribution of reverberation from the neighbor room.

In many embodiments, the audio apparatus may be arranged to adapt a level or gain for the reverberation signal.

Specifically, sources inside a room contribute their entire emitted energy to the room, and thus the reverberation. In many embodiments, for such sources, the source energies determine the relative levels with which these sources are downmixed in the downmixer for that room.

Based on source properties, a normalized source energy scaling factor can be calculated that indicates the scale factor to convert the sound source's signal into its corresponding total emitted energy. These normalized source energy scaling factors may be used in the downmixer 605 of the renderer 507 to obtain a downmixed signal that represents the total emitted energy of the sources.

It is also acknowledged that many embodiments may use coefficients that are based on a nominal gain (average of the directivity pattern, and including other applicable gains such as pre-gain and distance attenuation gain) at a nominal distance from the source, where also the reverberation energy data (DSR) is expressed in terms of source energy corresponding with a sampling at this nominal distance from the source, rather than the full emitted energy. The person skilled in the art will be able to translate the examples and embodiments based on full emitted energy to this alternative source energy representation scheme.

For sources outside the considered room, not all energy is contributing to the room's reverberation. The source emits all its energy in a different room or region and a fraction of that energy may leak into the considered room. The fraction of its energy leaking into the room is dependent on several factors, including:
Distance of the source to the room leaks.
Occlusion and diffraction of the source by obstacles in the other room affecting the path from source to the room leaks.
The number and size of room leaks.
The attenuation that the room leaks impose.

In some embodiments with reduced complexity, the energy fraction may be based on the (potentially frequency dependent) gain that is already calculated for the listener. That is, the listener is inside the room and the direct path rendering of sources in other rooms already may be taking into account distance, occlusion and diffraction and therefore provide a good approximation for the path from source to the room leaks.

Such an approach may not be entirely accurate as it may also include attenuation for occlusions and/or the distance travelled inside the considered room. However, it does not require additional calculation. If the gains for the listener are determined in such a way that the algorithm knows which factors are imposed by each room, it may also be part of the process to collect the gain only from factors outside the considered room and have very little additional computations.

In these embodiments, this gain is only one part of the energy scaling. It does not consider the size of the room leaks/transmission boundary regions. They typically do include the attenuation imposed by (at least one of) the transmission boundary regions. When, for example, the transmission boundary region is a doorway of 2 m², there is a lot more energy getting into the room than when it is a small window of 0.25 m².

A gain representing all attenuations between the source and a certain position (i.e. listener's head or right after entering the room through a transmission boundary region) can be advantageously defined as corresponding to the surface area of a human ear. This is typically in line with consecutive rendering using an HRTF pair. Therefore, the obtained gain can be squared and multiplied with the surface ratio to obtain an approximation of the energy introduced into the room, yielding the downmix coefficient for signal i, associated with the considered source:

$${d}_{i} = \sqrt{{SA}_{i} \cdot {g}_{i}^{2} \cdot \frac{{A}_{leak}}{{A}_{ear}}}$$

There may be multiple room leaks through which source energy reaches the considered room, these can be aggregated. For example, with the following equation:

$${d}_{i} = \sqrt{{\sum }_{j = 0}^{J - 1} {S}_{i} \cdot {g}_{i , j}^{2} \cdot {( {t}_{j} + {c}_{j} )}^{2} \cdot \frac{{A}_{l eak , j}}{{A}_{g a i n}}}$$

where dᵢ represents the downmix coefficient for signal i, Sᵢ the normalized source energy scale factor, g_{i,j} the (potentially frequency dependent) attenuation gain imposed on the path from the source associated with signal i to room leak j, tⱼ the transmission coefficient and cⱼ the coupling coefficient of room leak j, A_{leak,j} the surface area of room leak j, and Aₑₐᵣ the surface area associated with the gain (e.g. the human ear).

The gain g_{i,j} can be calculated in different ways, as is known in the art, simulating distance, occlusion and diffraction for direct path rendering. An example of a low complexity method could focus only on the direct path distance attenuation from the source to the room leak.

$${g}_{i , j} = \frac{{d}_{r e f}}{{d}_{i , j}}$$

where d_{i,j} is the distance from the position of source associated with signal i to the position associated with room leak j, and d_{ref} the reference distance of the signal/source where distance attenuation on the signal equals 1.

The audio apparatus may as previously described generate a first audio component that corresponds to a localized rendering of the reverberation signal from the sound source position (either as a point source or as an extent source).

In some embodiments, the audio apparatus may further be arranged to generate a second audio component by rendering the neighbor room reverberation signal as a reverberation signal for the listening room. Thus, in some embodiments, the reverberation in the neighbor room is in the listening room rendered as a combination of a localized sound and a diffuse reverberation sound. Such an approach may for example in many embodiments provide a more realistic experience of the scene.

In some embodiments, the reverberation signal may thus be fed to a path renderer 601 of the renderer 507 to result in a spatially localized rendering of the neighbor room reverberation signal. In addition, the neighbor room reverberation signal may be fed to the combiner 603 and combined with the reverberation signal generated for the listening room itself (and with the outputs from the path renderers 601).

The renderer 507 may include a path renderer for rendering acoustic path propagation to the listening position and the renderer may be arranged to feed the neighbor room reverberation signal to the path renderer. The renderer 507 may further be arranged to combine the neighbor room reverberation signal with an output of the path renderer(s).

The renderer 507 may in such cases be arranged to adapt a relative level for the two audio components.

In many embodiments, the rendering includes adapting a level of the first audio component (reflecting a localized audio source) relative to a level of the second audio component (reflecting a diffuse and non-localized reverberation) dependent on the listening position relative to the first transmission boundary region. Specifically, the renderer 507 may be arranged to increase the level of the first audio component relative to the level of the second audio component for an increasing distance from the listening position to the transmission boundary region/neighbor room. Thus, the closer the listener moves towards the transmission boundary region and the neighbor room, the stronger is the perception of localized sound relative to the diffuse sound contribution.

In some embodiments, the renderer may be arranged to adapt a level of the first audio component (reflecting a localized audio source) relative to a level of the second audio component (reflecting a diffuse and non-localized reverberation) dependent on a geometric property of the transmission boundary region, and specifically on the size of the transmission boundary region.

In many embodiments, the renderer 507 may be arranged to decrease the level of the first audio component relative to the level of the second audio component for an increasing size of the transmission boundary region. Thus, the larger the transmission boundary region is, the weaker is the perception of localized sound relative to the diffuse sound contribution.

The level adaptation may for example be used to generate a gradual transition between the two rooms. For example, a smoother and more natural transition of audio from one room to the other when a user moves between them can often be achieved. For example, a transition or cross-fading region may be defined for the listening position with the weighting of the localized and non-localized (diffuse) components being dynamically adapted as a function of the listening position within the region.

FIGS. 7-9 illustrate examples of sound source positions 701 and cross-fade/transition regions 703 for an exemplary transmission boundary region where the listening room is denoted by B and the neighbor room is denoted by A.

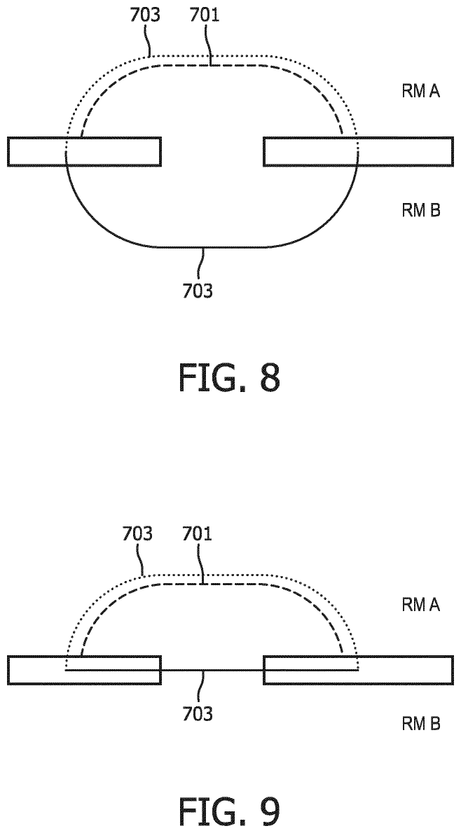

In FIG. 7, the sound source is a point source, and the transition region is an area around the boundary opening (represented by the transmission boundary region). In the example of FIG. 8, the sound source for the neighbor room reverberation signal is an extent sound source and in the example of FIG. 9, the transition region is only formed in the neighbor room.

In such examples, the relative levels for the two components may gradually change across the transition region to provide a smooth cross-fading transition.

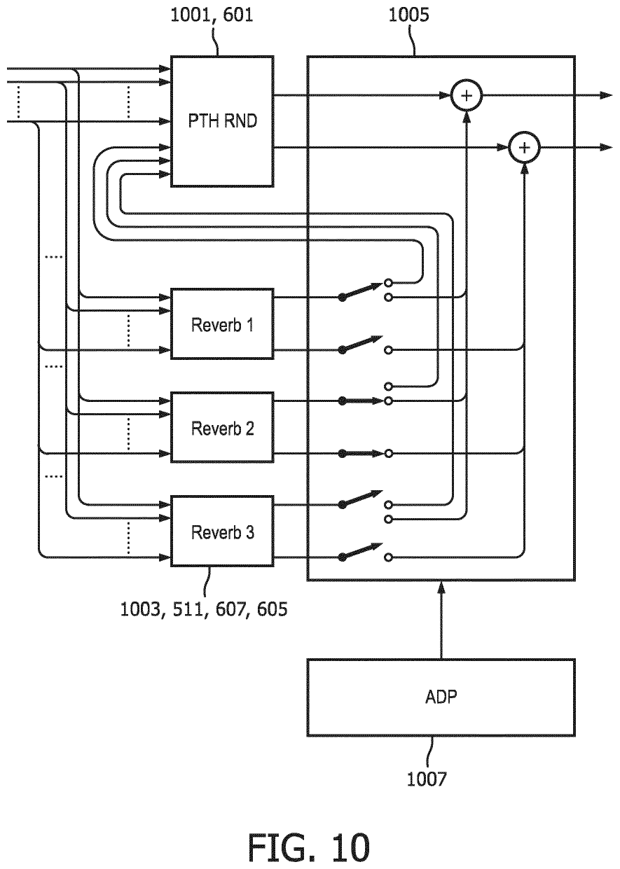

As illustrated in FIG. 10, in some embodiments, the audio apparatus may comprise a path renderer 1001 which is arranged to render acoustic paths for audio sources. The path renderer 1001 may specifically implement the path renderers 601 of FIG. 6.

The audio apparatus may further comprise a plurality of reverberators 1003 that are arranged to generate reverberation signals for rooms. The reverberators 1003 may specifically include the reverberator 511 as well as the downmixer 605 and reverberator 607 and may thus generate reverberation signals for the neighbor room and the listening room respectively. The reverberators 1003 may include reverberators for generating reverberation signals for other rooms.

The audio apparatus may further comprise a coupling circuit 1005 which is arranged to selectively couple reverberation signals from the outputs of the plurality of renderers 1003 to the path renderer 1001. Thus, the coupling circuit 1005 is capable of coupling reverberation signals, such as the neighbor room reverberation signal, to the input of the path renderer 1001 such that the signals can be rendered as localized signals.

The audio apparatus further comprises a combination circuit 1005 which is arranged to selectively combine reverberation signals from the renderers 1001 with each other and with an output signal from the path renderer 1001 and with reverberation signals directly. The result is an audio signal representing audio in the scene. The combination circuit 1005 may include the combiner 603.

In the example, the coupling circuit and the combination circuit 1005 are implemented by switches that can switch outputs of the reverberators 1003 between the input of the path renderer 1001 and the combiner function. However, it will be appreciated that in many embodiments, individual gains may be used that can adapt relative gains between coupling to the input of the path renderer.

The audio apparatus further comprises an adapter 1007 which is arranged to adapt levels of the reverberation signals for the coupling and for the combination. For example, the adapter 1007 may control the switches of FIG. 10 or may e.g. control and adapt gains for the paths from the reverberators 1003 to the input and output sides of the direct path renderer 1001.

The arrangement allows reverberation signals to be adapted and to be rendered as localized sources and/or as diffuse reverberation signals. It provides a very efficient approach which may be implemented with low complexity while providing high performance and substantial flexibility.

The adapter 1007 may specifically adapt the levels of the reverberation signals for respectively the direct path renderer input and the combination dependent on one or more of the following:
a) Metadata received with the audio data for the audio sources. For example, an importance function derived by the content creator that may increase or decrease the relative levels of the differing rooms beyond the (physically) simulated levels.
b) An acoustic property of the first transmission boundary region. For example, a reflection coefficient of the first transmission boundary region, where a larger reflection coefficient causes a relatively higher gain for the listening room reverberation signal to the input of the combiner.
c) A geometric property of the first transmission boundary region. For example, a surface area of the first transmission boundary region, where a larger surface area causes a relatively higher gain for a neighbor room reverberation signal to the input of the combiner.
d) the listening position. For example, a distance of the listener to the first transmission boundary region, where a smaller distance causes a relatively smaller gain for a reverberation signal to the input of the combiner.
e) An acoustic distance from the listening position to the transition region boundary;
f) An acoustic distance from the listening position to the sound source position; and
g) A size of the neighbor room. For example, a dimension of the neighbor room perpendicular to the first transmission boundary region, where a larger dimension causes a relatively smaller gain for a neighbor room reverberation signal to the input of the combiner.

As a specific example, the approach may in some embodiments generate reverberation audio from multiple rooms with significantly different characteristics by running multiple reverberators in parallel. Typically, one reverberator may be used for each room/acoustic environment that needs to be rendered.

For optimized processing, determining which rooms need to be rendered may be an important aspect when the number of rooms in the rendered scene increases to e.g. more than 3 or 4 rooms. This can be achieved in many different ways. For improved quality, the rooms may be ranked based on their perceptual relevance. This can be achieved by ranking the rooms according to their reverberation loudness at the listening position. Clearly, when the listener is in an environment with reverberation properties, that room is likely to be the most important room to simulate.

The number of sources in a room, and their loudness, may play an important role, ideally combined with the energy (DSR) of the room and further combined with the amount of room leaking/transmission to the listening room. E.g. a room relevance number for room k can be derived as:

$${R}_{k} = {L}_{k} * D S {R}_{1 \; 00 m s , k} * {A}_{l eak , k \to {k}_{c}}$$

where L denotes the combined average loudness of the sources in the room, DSR_{100ms,k} the frequency averaged DSR measured from 100 ms onwards, and A_{leak,k→k}_{_{c}} the effective leaking surface (e.g. corresponding to an effective size of the transmission boundary region) between room k and the room kc which comprises the listening position.

The effective leaking surface may be determined based on its transparency. E.g.

$${A}_{l eak , k \to c} = {\sum }_{j = 0}^{J - 1} {A}_{l eak , j} * ( {t}_{j} + {c}_{j} )$$

More advanced, and often also more complex, equations can be derived. For example, by taking into account distance and occlusion attenuation taking place between the sources in room k and the listening position.

Essentially each reverberator may represent a single room. The input signals from the sources in the scene are downmixed with appropriate (relative) levels to represent how much impact they have in the room before the reverberator creates the reverberant signal from it. This is often a binaural signal for playback on headphones but may also be a multi-channel signal for loudspeaker playback.

When the listener is inside a room, this is the appropriate way of rendering the reverberation signal of the associated reverberator. However, the reverberation signals from the other rooms should typically not be rendered as a fully diffuse signal reaching the listener from all sides. Instead, it may be rendered as a localizable source proximal to the corresponding transmission boundary region.

This rendering of reverberation signals may the same as when rendering normal sources, for which also distance attenuation, occlusion, diffraction and other acoustic effects may play a role. Typically, room transmission areas may be represented by an object with spatial extent matching the size of the area, so that the sound appears to originate from the entire room leak (often a door or window).

Therefore, the neighbor room reverberation signal may be fed into an already present direct path renderer and this may generate at least one new source associated with the neighbor room reverberation signal.

In many embodiments, the routing may not be a hard switch, as in FIG. 10 but may be controlled by a cross-fading coefficient, where both the diffuse representation as well as the reverberation source representation are active at the same time. This can be used to create a smooth transition when the listener is close to the room leak. In 6 DoF content, the listener often has the freedom to move from one room to another, and thus benefits from a diffuse representation smoothly transitioning into a source-based representation and vice versa.

For example, the cross-fade coefficient α_{xf} for room A reverberation may be 0.5 for listening positions at the room boundary, 1 for listening positions at least 1 m distance from the boundary in room A and 0 for listening positions at least 1 m distance from the boundary in room B. Simultaneously the cross-fade coefficient from room B reverberation may have the inverse relationship. When the listener is further away from the room leak, the cross-fade coefficient for the room that the listener is in, is 1 and for all other rooms 0, so that the reverberation for the room that the listener is in is fully diffuse and reverberation of all other rooms is fully directional.

Additionally, the reverberation signal of a room can be fed to early reflection processing and/or reverberation processing of other rooms. In most embodiments, these routed signals would not be subject to the cross-fading.

An advantageous way to achieve the proper mapping from the outputs of the outputs of the reverberators to the input of other reverberators (or to early reflection inputs), is to use a mapping matrix. As an example, a mapping matrix may map each reverberator output signal to all other reverberators' inputs but not to itself.

$${A}_{map} = ( \begin{matrix}0 & 1 & 1 & 1 \\ 1 & 0 & 1 & 1 \\ 1 & 1 & 0 & 1 \\ 1 & 1 & 1 & 0\end{matrix} )$$

When there are multiple transmission boundary regions, the same reverberation output signal may be processed for multiple reverberation sources. I.e. the same signal may be used for rendering multiple reverberation sources. This can be achieved by generating multiple reverberation sources, referencing the same signal.

When switching or cross-fading between diffuse representation and directional representation of the reverberation signal, it may be desirable to align these different renderings so that no artefacts occur. A spatial cross-fade may help with this, as a hard switch is often difficult to mask. A minimal artefact reduction technique for embodiments with hard switching between representations may be hysteresis, where there is a spatial distance between the threshold for switching from room A to room B vs the threshold for switching from room B to room A.

Further, an alignment of levels may be advantageous. In many embodiments it may be beneficial to ensure that the signal levels of both representations are stable and similar throughout the cross-fade region. This can, for example, be achieved by setting the reference distance (d_{ref}) of the reverberation source and the minimum listener-source distance (dₘᵢₙ) equal to the (common, average or maximum) perpendicular distance of the cross-fade boundary to the reverberation source.

It is typically not necessary to have stable levels throughout the cross-fade region. Some embodiments may align a level only at a certain sub-region.

Many other embodiments may target a significant fading of the reverberation level to a lower loudness as the listener is moving outside the room.

When a transmission boundary region increases in size, it will cause higher reverberation loudness in the other room. I.e. a large door will cause more reverberation energy to pass through than a small window. In order to introduce this effect, the signal rendered as a localizable source may be scaled according to the size of the room leak. The signal without extra gain may represent a reference room leak size. For example, A_{ref}=4 m². Room leaks with a different size may be assigned a gain proportional to the ratio of the room leak size to this reference room leak size.

$${g}_{r l s} = \frac{{A}_{leak , k \to {k}_{c}}}{{A}_{r e f}}$$

Alternatively, the extent rendering of the source may employ a level normalization mode that achieves a higher source loudness for a larger extent. For example, not attenuating the signals rendered as point sources spanning the extent to compensate for the amount of point sources, or ensuring that the combined signal power represented by the point sources spanning the extent scales according to the gain gᵣₗₛ from the equation above.

The terms audio and sound may be considered equivalent and interchangeable and may both refer to respectively physical sound pressure and/or electrical signal representations of such as appropriate in the context.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc. do not preclude a plurality. Reference signs in the claims are provided merely as a clarifying example shall not be construed as limiting the scope of the claims in any way.

Generally, examples of an audio apparatus and method therefor are indicated by below embodiments.

### EMBODIMENTS

1. An audio apparatus:
a first receiver (501) arranged to receive audio data for audio sources of a scene comprising multiple rooms;
a position circuit (505) arranged to determine a listening position in the scene;
a determiner (509) arranged to determine a first room comprising the listening position and a second room being a neighbor room of the first room;
a second receiver (503) arranged to receive spatial acoustic transmission data for the first room and the second room, the spatial acoustic transmission data describing a number of transmission boundary regions for the first room, each transmission boundary region having an acoustic transmission level for sound from the second room to the first room exceeding a threshold;
a first reverberator (511) arranged to determine a second room reverberation audio signal for the second room from at least one audio source in the second room and at least one property of the second room;
a sound source circuit (513) arranged to, for at least a first transmission boundary region of the number of transmission boundary regions, determine a sound source position in the second room for an audio source;
a renderer (507) arranged to render an audio signal for the listening position, the rendering including generating a first audio component by rendering the second room reverberation audio signal from the sound source position.
   2. The audio apparatus as claimed in claim 1 wherein the rendering is dependent on at least one of a geometric property and an acoustic property of the first transmission boundary region.
   3. The audio apparatus of any previous claim wherein a distance from the sound source position to the first transmission boundary region is no less than a tenth of a maximum distance within the first transmission boundary region.
   4. The audio apparatus of any previous claim wherein a distance from the sound source position to the first transmission boundary region is no less than a tenth of a maximum distance within the second room.
   5. The audio apparatus of any previous claim wherein a distance from the sound source position to the first transmission boundary region is no less than 20 cm.
   6. The audio apparatus of any previous claim wherein the rendering includes rendering for an acoustic path from the sound source position to the listening position through the first transmission boundary region.
   7. The audio apparatus of any previous claim wherein the rendering includes generating a second audio component by rendering the second room reverberation signal as a reverberation audio component.
   8. The audio apparatus of claim 7 wherein the rendering includes adapting a level of the first audio component relative to a level of the second audio component in response to the listening position relative to the first transmission boundary region.
   9. The audio apparatus of claim 8 wherein the rendering includes increasing the level of the first audio component relative to the level of the second audio component for an increasing distance to the second room.
   10. The audio apparatus of any of claims 7-9 wherein the rendering includes adapting a level of the first audio component relative to a level of the second audio component in response to a size of the first transmission boundary region.
   11. The audio apparatus of any previous claim wherein the renderer (507) is arranged to render the second room reverberation audio signal from the sound source position as a spatially extended sound source.
   12. The audio apparatus of any previous claim wherein the renderer (506) comprises:
a path renderer (1001) for rendering audio for acoustic paths;
a plurality of reverberators (1003) arranged to generate reverberation signals for rooms, the plurality of reverberators including the first reverberator;
a coupling circuit (1005) for coupling reverberation signals from the plurality of renderers to the path renderer (1001);
a combination circuit (1005) for combining reverberation signals from the plurality of renderers (1003) and an output signal from the path renderer (1001) to generate a combined audio signal; and
an adapter (1007) for adapting levels of the reverberation signals for the coupling by the coupling circuit (1005) and for the combination by the combination circuit (1005).
   13. The audio apparatus of claim 12 wherein the adapter (1007) is arranged to adapt the levels of the reverberation signals in response to at least one of:
metadata received with the audio data for the audio sources;
an acoustic property of the first transmission boundary region;
a geometric property of the first transmission boundary region; the listening position;
an acoustic distance from the listening position to the sound source position; and
a size of the first transmission boundary region.
   14. The audio apparatus of any previous claim wherein the first reverberator (511) is further arranged to generate the second room reverberation signal in response to a first room reverberation signal.
   15. A method of operation for an audio apparatus, the method comprising:
receiving audio data for audio sources of a scene comprising multiple rooms;
determining a listening position in the scene;
determining a first room comprising the listening position and a second room being a neighbor room of the first room;
receiving spatial acoustic transmission data for the first room and the second room, the spatial acoustic transmission data describing a number of transmission boundary regions for the first room, each transmission boundary region having an acoustic transmission level of sound from the second room to the first room exceeding a threshold;
determining a second room reverberation audio signal for the second room from at least one audio source in the second room and at least one property of the second room;
for at least a first transmission boundary region of the number of transmission boundary regions, determining a sound source position in the second room for an audio source;
rendering an audio signal for the listening position, the rendering including generating a first audio component by rendering the second room reverberation audio signal from the sound source position.

1. An audio apparatus comprising:
a first receiver circuit,
wherein the first receiver circuit is arranged to receive audio data for audio sources of a scene,
wherein the scene comprises multiple rooms;
a position circuit, wherein the position circuit is arranged to determine a listening position in the scene;
a determiner circuit,
wherein the determiner circuit is arranged to determine a first room and a second room,
wherein the first room comprises the listening position,
wherein the second room is a neighbor room of the first room;
a second receiver circuit,
wherein the second receiver circuit is arranged to receive spatial acoustic transmission data for the first room and the second room,
wherein the spatial acoustic transmission data describes a plurality of transmission boundary regions for the first room,
wherein each transmission boundary region of the plurality of transmission boundary regions has an acoustic transmission level for sound from the second room to the first room exceeding a threshold;
a first reverberator circuit, wherein the first reverberator circuit is arranged to determine a second room reverberation audio signal for the second room from at least one audio source in the second room and a property selected from the group consisting of a geometric property of the second room and an acoustic property of the second room;
a sound source circuit, wherein the sound source circuit is arranged to determine a sound source position in the second room for the at least one audio source in the second room for at least one of the plurality of transmission boundary regions; and
a renderer circuit, wherein the renderer circuit is arranged to render an audio signal for the listening position so as to comprise a first audio component generated by rendering the second room reverberation audio signal from the sound source position.

2. The audio apparatus as claimed in claim 1, wherein the rendering is dependent on a property selected from the group consisting of a geometric property of the first transmission boundary region and an acoustic property of the first transmission boundary region.

3. The audio apparatus of claim 1, wherein the sound source circuit is arranged to determine the sound source position if a distance from the sound source position to the first transmission boundary region is at least a tenth of a maximum distance within the first transmission boundary region.

4. The audio apparatus of claim 1, wherein the sound source circuit is arranged to determine the sound source position if a distance from the sound source position to the first transmission boundary region is at least a tenth of a maximum distance within the second room.

5. The audio apparatus of claim 1, wherein the sound source circuit is arranged to determine the sound source position if a distance from the sound source position to the first transmission boundary region is at least 20 cm.

6. The audio apparatus of claim 1, wherein the renderer circuit is arranged to generate the first audio component by rendering the second room reverberation audio signal from the sound source position to the listening position along an acoustic path passing through the first transmission boundary region.

7. The audio apparatus of claim 1, wherein the rendering comprises generating a second audio component by rendering the second room reverberation signal as a reverberation audio component.

8. The audio apparatus of claim 7, wherein the rendering comprises adapting a level of the first audio component relative to a level of the second audio component in response to the listening position relative to a position of the first transmission boundary region.

9. The audio apparatus of claim 8, wherein the rendering comprises increasing the level of the first audio component relative to the level of the second audio component for an increasing distance from the listening position to the second room.

10. The audio apparatus of claim 1, wherein the rendering comprises adapting a level of the first audio component relative to a level of the second audio component in response to a size of the first transmission boundary region.

11. The audio apparatus of claim 1, wherein the renderer circuit, is arranged to render the second room reverberation audio signal from the sound source position as a spatially extended sound source.

12. The audio apparatus of claim 1, wherein the renderer circuit, comprises:
a path renderer circuit, wherein the path renderer circuit is arranged to render audio for at least one acoustic path;
a plurality of reverberator circuits,
wherein the first receiver circuit is arranged to generate reverberation signals for the first room and the second room,
wherein the plurality of reverberator circuits comprises the first reverberator circuit;
a coupling circuit, wherein the coupling circuit is arranged to couple reverberation signals from the plurality of reverberator circuits, to the path renderer circuit;
a combination circuit,
wherein the combination circuit is arranged to combine reverberation signals from the plurality of reverberator circuits and an output signal from the path renderer circuit so as to generate a combined audio signal; and
an adapter circuit,
wherein the adapter circuit is arranged to adapt levels of the reverberation signals for the coupling by the coupling circuit,
wherein the adapter circuit is arranged to adapt levels of the reverberation signals for combination by the combination circuit.

13. The audio apparatus of claim 12, wherein the adapter circuit is arranged to adapt the levels of the reverberation signals in response to an audio property, wherein the audio property is selected from the group consisting of metadata received with the audio data for the audio sources, an acoustic property of the first transmission boundary region, a geometric property of the first transmission boundary region, the listening position, an acoustic distance from the listening position to the sound source position and a size of the first transmission boundary region.

14. The audio apparatus of claim 1, wherein the first reverberator circuit, is arranged to generate the second room reverberation signal in response to a first room reverberation signal.

15. The audio apparatus of claim 1, wherein the sound source circuit is arranged to generate the sound source position based on a position of the first transmission boundary region.

16. A method comprising:
receiving audio data for audio sources of a scene, wherein the scene comprises multiple rooms;
determining a listening position in the scene;
determining a first room and a second room,
wherein the first room comprises the listening position,
wherein the second room is a neighbor room of the first room;
receiving spatial acoustic transmission data for the first room and the second room,
wherein the spatial acoustic transmission data describes plurality of transmission boundary regions for the first room,
wherein each transmission boundary region of the plurality of transmission boundary regions has an acoustic transmission level of sound from the second room to the first room exceeding a threshold;
determining a second room reverberation audio signal for the second room from at least one audio source in the second room and a property selected from the group consisting of a geometric property of the second room and an acoustic property of the second room;
determining a sound source position in the second room for the at least one audio source in the second room for at least one of the plurality of transmission boundary regions; and
rendering an audio signal for the listening position so as to comprise a first audio component generated by rendering the second room reverberation audio signal from the sound source position.

17. The method as claimed in claim 16, wherein the rendering is dependent on a property selected from the group consisting of a geometric property of the first transmission boundary region and an acoustic property of the first transmission boundary region.

18. The method as claimed in claim 16, further comprising determining the sound source position if a distance from the sound source position to the first transmission boundary region is at least a tenth of a maximum distance within the first transmission boundary region.

19. The method as claimed in claim 16, further comprising determining the sound source position if a distance from the sound source position to the first transmission boundary region is at least a tenth of a maximum distance within the second room.

20. The method as claimed in claim 16, further comprising determining the sound source position if a distance from the sound source position to the first transmission boundary region is at least 20 cm.

21. The method as claimed in claim 16, further comprising generating the first audio component by rendering the second room reverberation audio signal from the sound source position to the listening position along an acoustic path passing through the first transmission boundary region.

22. The method as claimed in claim 16, wherein the rendering comprises generating a second audio component by rendering the second room reverberation signal as a reverberation audio component.

23. The method as claimed in claim 22, wherein the rendering comprises adapting a level of the first audio component relative to a level of the second audio component in response to the listening position relative to a position of the first transmission boundary region.

24. The method as claimed in claim 23, wherein the rendering comprises increasing the level of the first audio component relative to the level of the second audio component for an increasing distance from the listening position to the second room.

25. The method as claimed in claim 16, wherein the rendering comprises adapting a level of the first audio component relative to a level of the second audio component in response to a size of the first transmission boundary region.

26. The method as claimed in claim 16, further comprising rendering the second room reverberation audio signal from the sound source position as a spatially extended sound source.

27. The method as claimed in claim 16, further comprising:
rendering audio for at least one acoustic path;
generating reverberation signals for the first room and the second room;
combining the reverberation signals so as to generate a combined audio signal;
adapting levels of the reverberation signals for the coupling; and
adapting levels of the reverberation signals for the combining.

28. The method as claimed in claim 27, further comprising adapting the levels of the reverberation signals in response to an audio property, wherein the audio property is selected from the group consisting of metadata received with the audio data for the audio sources, an acoustic property of the first transmission boundary region, a geometric property of the first transmission boundary region, the listening position, an acoustic distance from the listening position to the sound source position and a size of the first transmission boundary region.

29. The method as claimed in claim 16, further comprising generating the second room reverberation signal in response to a first room reverberation signal.

30. The method as claimed in claim 16, further comprising generating the sound source position based on a position of the first transmission boundary region.

31. A computer program stored on a non-transitory medium, wherein the computer program when executed on a processor performs the method as claimed in claim 16.
